(19) United States
(12) Patent Application Publication
(10) Pub. No.: US 2012/0054027 A1
(43) Pub. Date: Mar. 1, 2012

(54) NETWORK BASED ADVERTISEMENT SYSTEM

(75) Inventors: Randolph Preston McAfee, San Marino, CA (US); Vijay Krishna Narayanan, Mountain View, CA (US); Jayavel Shanmugasundaram, Santa Clara, CA (US); Rajesh G. Parekh, San Jose, CA (US)

(73) Assignee: Yahoo! Inc., Sunnyvale, CA (US)

(21) Appl. No.: 12/871,240

(22) Filed: Aug. 30, 2010

(51) Int. Cl. G06Q 30/00

(52) U.S. Cl. 705/14.49

(57) ABSTRACT

A network based advertisement system includes an optimizer configured to forecast a supply of opportunities, forecast a supply of guaranteed contracts, and forecast a supply of non-guaranteed contracts. Each opportunity represents a user visiting a webpage. Each guaranteed contract guarantees the matching of an advertisement to a number of opportunities. Each non-guaranteed contract guarantees a user event associated with an advertisement. The optimizer then generates a plan for matching contracts to opportunities based on the forecasted supply of opportunities, the forecasted supply of guaranteed contracts, the forecasted supply of non-guaranteed contracts, and an objective function that balances a group of parameters that define the representativeness of contracts, a cost associated with not serving non-guaranteed contracts, and performance objectives associated with contracts.

### BACKGROUND

The Internet has emerged as a powerful advertising tool. It is commonplace to see advertisements on many web sites. For example, advertisements may be displayed on search web sites and may be targeted to individuals based upon search terms provided by the individuals. Other web sites, such as news and sports web sites, may provide space for advertisements. The owners of these web sites may sell advertising space to advertisers to offset the costs associated with operating the web sites as well as to turn a profit.

To place an advertisement, an advertiser may enter into a contract with a publisher that operates an ad serving system to serve a number of advertisement impressions. An impression corresponds to the display of an advertisement to a user. For example, the advertiser may purchase 10,000 impressions for $100 and may specify a particular target audience, such as users that like sports. The easiest way for the publisher to satisfy this contract is to serve the advertisements to webpages more likely to be visited by the target audience, which for this example might include sports webpages. Publishers sometimes refer to the supply of users visiting such webpages as a premium inventory of opportunities. Each opportunity represents a user visiting the webpage. The opportunities are premium because they correspond to users visiting a webpage with a defined target audience. The contract will not be satisfied until the publisher serves the 10,000 impressions. Thus, this type of contract is considered a guaranteed contract because the advertiser is guaranteed that his advertisement will be shown 10,000 times.

In other instances, an advertiser may enter into a contract with a publisher whereby the advertiser specifies a performance objective, such as payment of a money amount each time a user clicks on an advertisement, or each time a click of the advertisement results in a conversion. However, a publisher cannot guarantee that a user will ever click or that a click will result into an eventual conversion. Thus, this type of contract is considered a non-guaranteed contract.

Each of the contracting methods described above requires a different ad serving system that is configured to serve advertisements according to the contract specifications. One problem with these systems is that neither allows an advertiser to specify both a desired number of impressions and performance objectives. The reason for this is that the systems compete against each other for the same opportunities. Another problem is that the supply of premium inventory tends to be consumed by guaranteed contracts as the impressions contracted for in the contracts must be delivered. Therefore, the non-guaranteed contracts may, more often than not, be served to webpages where it is less likely a user may click.

### BRIEF DESCRIPTION OF THE DRAWINGS

FIG. 1 is an exemplary system for booking and serving advertisements;

FIG. 2 is an exemplary webpage that may be communicated to an advertiser to enable the specification of advertisement information;

FIG. 3 illustrates exemplary operations performed by an optimizer of the system shown in FIG. 1;

FIG. 4 illustrates exemplary operations performed by an ad server of the system shown in FIG. 1; and

FIG. 5 illustrates a general computer system that may represent any of the computing devices referenced herein.

### DETAILED DESCRIPTION

The embodiments below describe an exemplary embodiment of a system for booking and serving advertisements. The system enables advertisers to specify a desired number of impressions and objective information associated with an advertisement, which results in a contract with a guaranteed component and a non-guaranteed component. In other words, the system enables advertisers to book a guaranteed contract to ensure access to premium inventory, and the advertiser may additionally specify a performance premium for the specific performance objective in which the advertiser is interested.

The system includes an optimizer that generates a plan for matching opportunities to advertiser contracts. The plan is communicated to an ad server that is configured to match contracts to opportunities according to the plan. The optimizer generates the plan based on a forecasted supply of opportunities, a forecasted supply of guaranteed contracts, a forecasted supply of non-guaranteed contracts, and an objective function that balances a group of parameters that define the representativeness of contracts, a cost associated with not serving non-guaranteed contracts, and performance objectives associated with contracts.

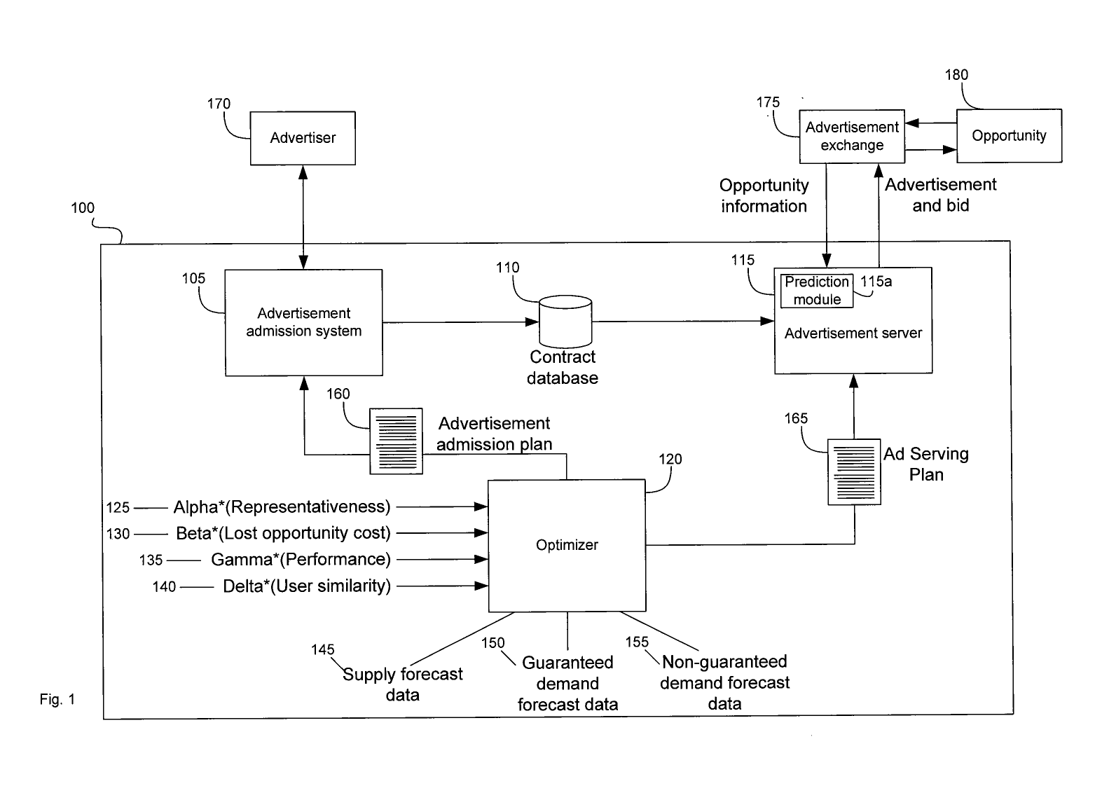

FIG. 1 is an exemplary system 100 for booking and serving advertisements. The system 100 includes an advertisement admission system (AAS) 105, an advertisement server 115 (ad server), and an optimizer 120. The various components of the system 100 may reside on a single computer system or be distributed among several computers interconnected by a communication network.

The AAS 105, ad server 115, and optimizer 120 may correspond to an Intel®, AMD®, or PowerPC® based computer or a different computer. The AAS 105, ad server 115, and optimizer 120 may include an operating system, such as a Microsoft Windows®, Linux, or other Unix® based operating system. The AAS 105, ad server 115, and optimizer 120 may be configured to communicate with other computers via an interface, such as a network interface.

The advertisement admission system (AAS) 105 includes code, logic, and/or other circuitry that enables advertisers 170 to enter into a contract with an advertisement network operator that operates the system 100 for the delivery of web-based advertisements. In some instances, the advertisement network operator may also correspond to a web site publisher that publishes webpages upon which advertisements are shown. The AAS 105 may communicate a webpage to the advertiser 170 that enables the advertiser 170 to open an account with the publisher and provide information for setting up an advertisement campaign. The webpage may enable the advertiser 170 to upload an advertisement creative, such as the graphics of an advertisement. The webpage may also enable the advertiser 170 to specify advertisement information that defines the circumstances under which an advertisement is to be communicated to an opportunity (i.e., a user). The information above is stored to a contract database 110.

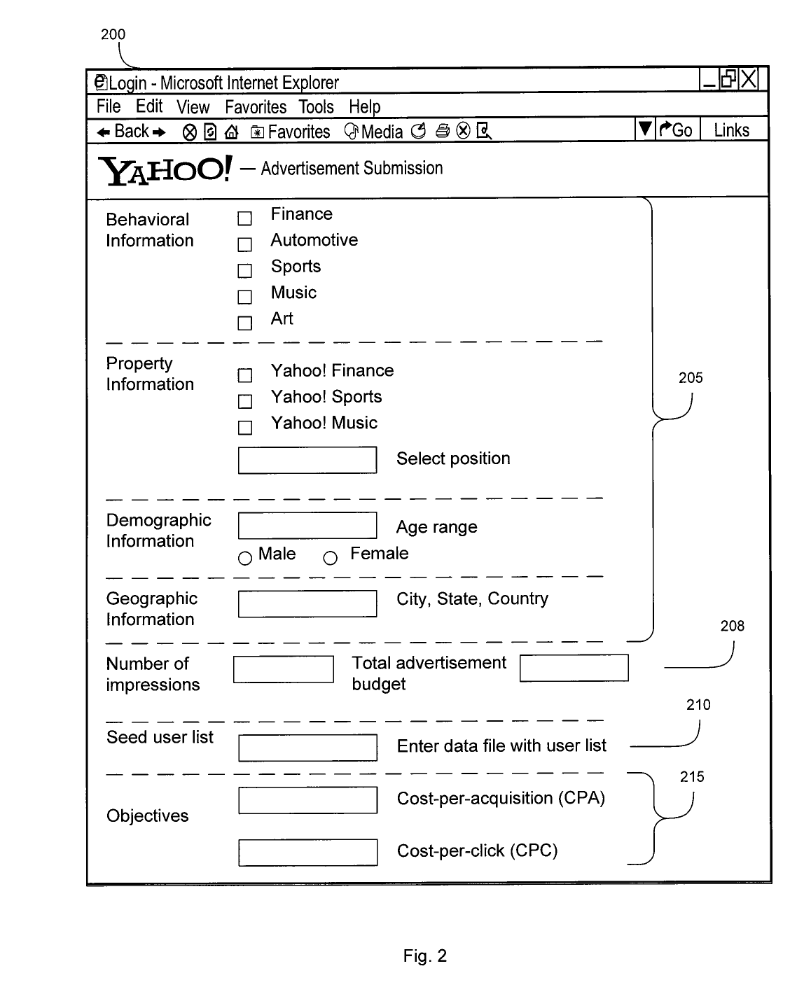

FIG. 2 is an exemplary webpage 200 that may be communicated to an advertiser 170 (FIG. 1) to enable the specification of advertisement information. The webpage 200 may include target fields 205 that enable specifying target information. The target fields 205 may include fields for specifying user behavior information. For example, options for targeting an audience interested in finance, automotive, sports, music, art, or other hobbies may be provided. The target fields 205 may include fields for specifying demographic information, such as an age range and gender of a target audience. The target fields 205 may include fields for specifying geographic information such as a city, state, or country of a target audience. The target fields 205 may include fields for specifying a property upon which an advertisement is to be displayed, such as a Yahoo! finance, sports, music webpage, or a different webpage.

The webpage 200 may include fields 208 for specifying a desired number of impressions to be delivered to opportunities that match a specified target audience, and a total advertisement budget the advertiser 170 is willing to spend.

The webpage may include a seed user list field 210 that enables an advertiser 170 to upload a list of users that typify the type of audience the advertiser 170 is interested in. In some instances, information about each user in the seed user list 210 may have been previously stored in the system. The previously stored information may include behavioral, demographic, geographic, or other information that defines the user. The information may include statistical information about the frequency with which the user clicks on advertisements and the type of advertisements clicked. Other information about the user may be stored.

The webpage 200 may include objective fields 215 that enable an advertiser 170 to specify a money amount the advertiser 170 will pay for a user event, such as a user-click associate with an advertisement or an acquisition/conversion, which occurs when a user click results in a purchase or other action associated with the advertisement.

The information specified by the advertiser 170 is utilized to generate a contract between the advertiser 170 and the publisher operating the system 100. The contract has both a guaranteed component and a non guaranteed component. The guaranteed component corresponds to the number of impressions to be delivered to the target audience. The non-guaranteed component corresponds to the performance objectives for clicks and/or conversions of the advertisement. Thus, the webpage 200 enables the advertiser 170 to book a guaranteed contract to ensure access to premium inventory, and the advertiser 170 may additionally specify a performance premium for the specific performance objective in which the advertiser 170 is interested.

Returning to FIG. 1, the optimizer 120 includes code, logic, and/or circuitry that enables the generation of an admission plan 160 and an ad serving plan 165. The optimizer 120 is configured to communicate the ad serving plan 165 to the ad server 175 and the ad admission plan 160 to the AAS 105. The respective plans produced by the optimizer 120 may be updated on a periodic basis, such as every few hours, so that the plan takes into consideration new estimates for supply, demand, and delivered impressions.

The ad serving plan 165 defines statistical information that controls the way in which the ad server 175 matches contracts to opportunities. For example, the ad serving plan 165 may instruct the ad server 115 to match contracts that specify a user similarity list to similar opportunities 20% of the time. The ad serving plan 165 may instruct the ad server 115 to match contracts specifying performance objectives to high-clicker opportunities (opportunities likely to produce a click) 10% of the time. The ad serving plan 165 may instruct the ad server 115 to increase the representativeness of the matches. The ad serving plan 165 may specify additional instructions and/or various combinations of the instructions described above.

The admission plan 160 provides instructions to the AAS 105 regarding available inventory and an amount to charge for the inventory. For example, the admission plan 165 may specify an amount of impression inventory available that targets a particular target audience. The admission plan 165 may also specify an amount to charge for impressions purchased from the available inventory. The AAS 105 may communicate the number of available impressions and the purchase price for the impressions to an advertiser 170 during ad submission.

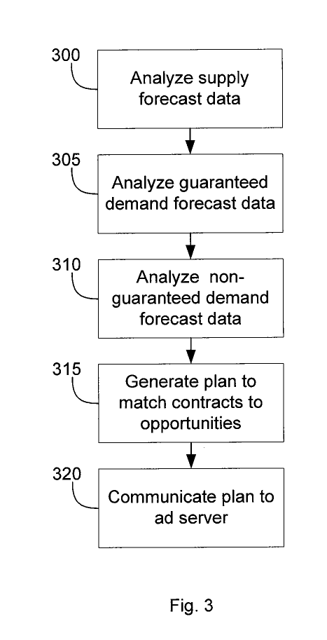

FIG. 3 illustrates exemplary operations performed by the optimizer 120. At block 300, the optimizer 120 analyzes supply forecast data 145 (FIG. 1) to predict opportunities available at a future time. The supply forecast data 145 may define opportunities that were served at some previous time, such as opportunities served on a particular day and at a particular time. Characteristics that define each opportunity may also be defined by the supply forecast data 145. The supply forecast data 145 may be thought of as pools or sets of opportunities where each pool represents opportunities that share certain characteristics. A given opportunity may belong to more than one pool.

At block 305, the optimizer 120 analyzes guaranteed demand forecast data 150 that predicts the demand for available impression inventory from guaranteed contracts. The guaranteed demand forecast data 150 may define guaranteed contracts that were booked at some previous time, such as contracts booked on a particular day and at a particular time. Targeting information for each contract may also be defined by the guaranteed demand forecast data 150. The guaranteed demand forecast data 150 may be thought of as pools or sets of contracts where each pool represents contracts that share certain targeting characteristics. A given contract may belong to more than one pool.

At block 310, the optimizer 120 analyzes non-guaranteed demand forecast data 155 that predicts the demand associated with non-guaranteed contracts. The non-guaranteed demand forecast data 155 may define non-guaranteed contracts that were booked at some previous time, such as contracts booked on a particular day and at a particular time. Targeting information for each contract and a cost-per-click or conversion specified in the contract may also be defined by the non-guaranteed demand forecast data 155. The non-guaranteed demand forecast data 155 may be thought of as pools or sets of contracts where each pool represents contracts that share certain targeting characteristics. A given contract may belong to more than one pool.

At block 315, the optimizer 120 generates an ad serving plan 165 with instructions for matching contracts to opportunities. The optimizer 120 matches the supply to the demand using an objective function that balances several factors to produces an optimal ad serving plan 165. In one implementation, the objective function may be expressed as:

Objective function=alpha*(Representative allocation of GD delivery)+beta*(Opportunity cost of NGD)+gamma*(Performance)+delta*(User-similarity metric)

where alpha 125 (FIG. 1), beta 130 (FIG. 1), gamma 135 (FIG. 1), and delta 140 (FIG. 1) are weights for the various terms of the objective function.

The first factor, alpha 125, operates to control the representativeness of guaranteed contract allocation in the ad serving plan 165. For a given contract, an increased representativeness results in that contract being matched to a broader spectrum of opportunities. For example, a guaranteed contract may indicate that an advertisement is to be shown 10,000 times to a target audience consisting of males. No other targeting information may be provided. In a non-representative allocation, the advertisement may, for example, be shown to males that live in the same city or that share the same hobby and/or other defining characteristics. In a highly representative allocation, the advertisement may be shown to any male opportunities. The allocation is more representative because the defining characteristics of these males may vary significantly. For example, the geographic locations, hobbies, ages, and other characteristics, to name a few, may vary.

The second factor, beta 130, operates to control the cost associated with not serving a non-guaranteed contract to an opportunity that has an expected return in the ad serving plan. In some instances, a publisher may be able to identify users likely to click on an advertisement. Serving an advertisement from a guaranteed contract to such an opportunity rather than an advertisement associated with a non-guaranteed contract represents a lost opportunity to satisfy the non-guaranteed contract because, potentially, the advertisement from the guaranteed contract could have been served to a different opportunity not as likely to produce a click or conversion. In other words, serving the advertisement from the non-guaranteed contract may have resulted in a click and, therefore, a money amount being paid to the publisher for providing the click. The second term represents this tradeoff in the objective function. Increasing the second factor may result in a plan that matches more non-guaranteed contracts to opportunities determined to be more likely to produce a click or a conversion.

The third factor, gamma 135, operates to control the probability that a contract with performance objectives is matched to an opportunity likely to produce a click or a conversion rather than a different opportunity that otherwise meets the targeting requirements associated with the contract. The objectives correspond to money amounts specified in contracts for user events, such as clicks or conversions.

The fourth factor, delta 140, operates to control the probability of matching contracts that specify a seed user list to opportunities that match the users in the seed user list rather than a different opportunity that otherwise meets the targeting requirements associated with the contract. Opportunities match users in the seed user list when characteristics associated with the opportunity (e.g., gender, geographic location, hobbies) match characteristics associated with users in the in the seed user list. The characteristics associated with the users in the seed user list may have been previously determined by the system.

The weights described above enable tuning the objective function to emphasize different factors in the ad serving plan 165. The publisher may periodically adjust the weights to change the ad serving plan 165. For example, the publisher may find that performance objectives of the contracts are not being met with sufficient frequency. To rectify this, the publisher may adjust the weight associated with the third factor to generate an ad serving plan 165 that places more emphasis on meeting the objectives specified in the contracts.

At block 320, the ad serving plan 165 is communicated to the ad server 115. The ad server 115 then matches advertisements to opportunities according to the ad serving plan 165.

Returning to FIG. 1, the ad server 115 includes code, logic, and/or circuitry that enables receiving information that defines an opportunity and serving an advertisement and bid associated with the received opportunity. The ad server 115 is configured to match contracts to opportunities according to the ad serving plan 165 communicated from the optimizer 120. The advertisements served are selected from the contract database 110.

The ad server 115 may include a prediction module 115a that provides estimates of the probability of a user event of interest, such as a click or a conversion, using as much information as is available during the ad serving time. For example, the information may include attributes associated with the user, such as the web browsing history of the user, the demographics of the user, and the geographic location of the user. In addition, the information may include the context in which the ad serving is to occur. For example, the information may include data that defines the content of the page, the time of day and day of week of ad serving, meta-data about the ad itself, including, for example, the category of the ad, the text and image attributes of the ad, attributes of the advertiser, and of the advertisement campaign.

In one implementation, the prediction module 115a is configured to implement machine learning models trained on historical information that define user behaviors related to viewing certain types of advertisements, and also clicks and conversions associated with users. These machine learning models may be represented by different model structures, such as decision trees including ordinary and boosted trees, different types of regressions (linear, logistic, Poisson etc.) trained with or without constraints on the magnitude and sign of the weights, support vector machines, online learning models configured to learn the parameters of the models in real time using explore/exploit schemes, or a different model structure.

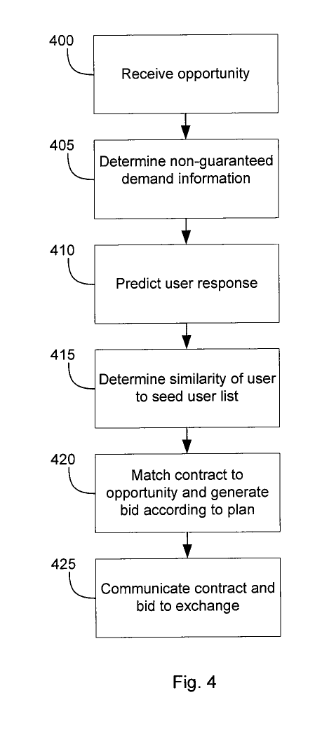

FIG. 4 illustrates exemplary operations performed by the ad server 115. At block 400, an opportunity 180 is received. The opportunity 180 may be communicated from an advertisement exchange 175 (FIG. 1) where other advertisers are bidding for the placement of advertisements. The information communicated from the advertisement exchange 175 may include information that defines the opportunity 180. For example, the information may include data that defines a cookie associated with the opportunity 180. A cookie is a data file stored on a user's computer that identifies the user. The information may specify data that defines the content of the web page through which the opportunity 180 was received. For example, the information may specify a URL of the web page. Other information described above may also be included.

At block 405, non-guaranteed demand information for the opportunity 180 may be determined. The non-guaranteed demand information may be communicated from the advertisement exchange 175 and may include information such as the current bid amount for the opportunity 180 and the number of bids being placed on the opportunity 180.

At block 410, the prediction module 115a of the ad server 115 predicts a user response to advertisements associated with contracts in the contract database 110. For example, the prediction module 115a may generate a score for each contract in the contract database 110. The score may represent the likelihood that a user associated with the opportunity 180 will click on the advertisement associated with the contract.

At block 415, the ad server 115 determines whether the opportunity 180 matches any users specified in a seed user list provided in the contracts stored in the contract database 110. A score may be generated for each contract in the contract database 110. The score may represent how close of a match the opportunity 180 is to users in the seed user list.

At block 420, the ad server 115 matches an advertisement to an opportunity 180 communicated from the advertisement exchange 175. The ad server 115 also determines a bid to be associated with the advertisement. Determination of an advertisement to select is based on information in the ad serving plan 165 communicated from the optimizer 120. For example, the ad serving plan 165 may define a more representative allocation of contracts to opportunities. In this case, the ad server 115 may select a contract related to the opportunity 180 that has not been previously served to the same opportunity 180. In other words, the ad server 115 may select contracts so that the impressions requested in the contracts are distributed among a more diverse set of opportunities, such as opportunities that match the target information of the contract, but are from different geographic regions.

Where the ad serving plan 165 defines an allocation for minimizing the lost opportunity cost associated with not serving a non-guaranteed contract, the ad server may select a related advertisement, but specify a lower bid amount to increase the chances of a non-guaranteed contract being matched to an opportunity 180.

Where the ad serving plan 165 defines an allocation for maximizing the performance objectives of the guaranteed contracts, the ad server 115 may attempt to increase the bid amount to increase the chances that the advertisement associated with the contract wins the bid at the advertisement exchange 175.

Where the ad serving plan 165 defines an allocation for maximizing the chances of serving an advertisement to an opportunity similar to a user in a seed user list, the ad server 115 may place more emphasis on matching contracts that specify a seed user list with opportunities 180 with characteristics similar to those of the users in the seed user list.

At block 420, the ad server 115 may communicate the advertisement associated with the selected contract and a bid amount to the advertisement exchange 175.

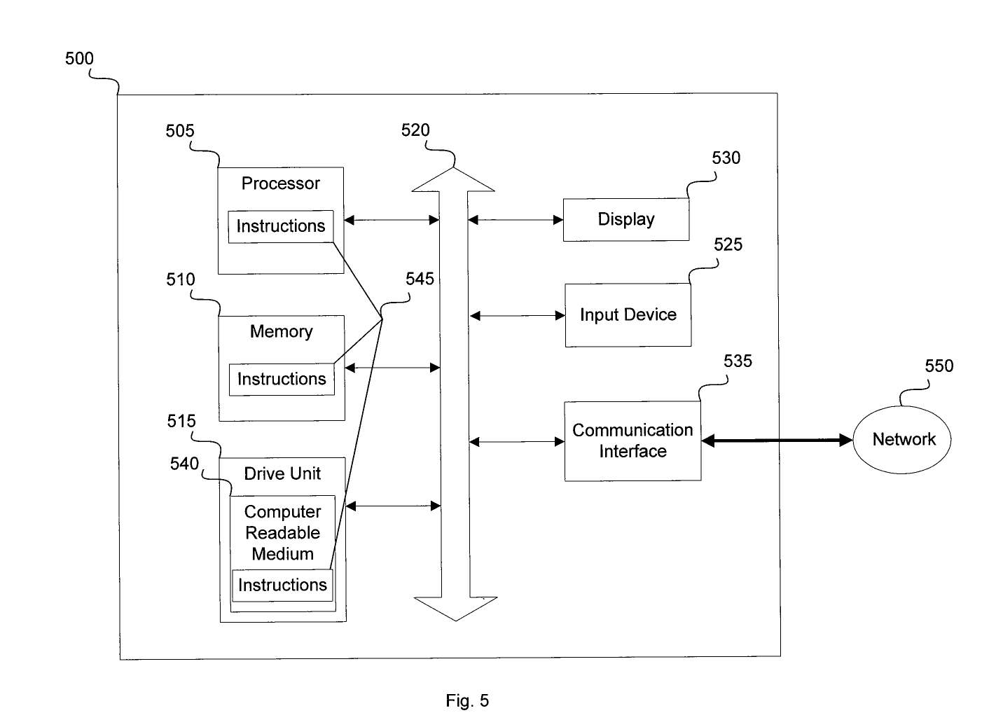

FIG. 5 illustrates a general computer system 500, which may represent the AAS 105, the optimizer 120, the ad server 115, or any other computing devices referenced herein. The computer system 500 may include a set of instructions 545 that may be executed to cause the computer system 500 to perform any one or more of the methods or computer-based functions disclosed herein. The computer system 500 may operate as a stand-alone device or may be connected, e.g., using a network, to other computer systems or peripheral devices.

In a networked deployment, the computer system 500 may operate in the capacity of a server or as a client-user computer in a server-client user network environment, or as a peer computer system in a peer-to-peer (or distributed) network environment. The computer system 500 may also be implemented as or incorporated into various devices, such as a personal computer or a mobile device, capable of executing a set of instructions 545 (sequential or otherwise) that specify actions to be taken by that machine. Further, each of the systems described may include any collection of sub-systems that individually or jointly execute a set, or multiple sets, of instructions to perform one or more computer functions.

The computer system 500 may include one or more memory devices 510 on a bus for communicating information, such as the contract database 110 (FIG. 1). In addition, code operable to cause the computer system to perform any of the acts or operations described herein may be stored in the memory 510. The memory 510 may be a random-access memory, read-only memory, programmable memory, hard disk drive or any other type of memory or storage device.

The computer system 500 may include a display 530, such as a liquid crystal display (LCD), a cathode ray tube (CRT), or any other display suitable for conveying information. The display 530 may act as an interface for the user to see the functioning of the processor 505, or specifically as an interface with the software stored in the memory 510 or in the drive unit 515.

Additionally, the computer system 500 may include an input device 525, such as a keyboard or mouse, configured to allow a user to interact with any of the components of system 500.

The computer system 500 may also include a disk or optical drive unit 515, such as the high-latency storage 110 (FIG. 1). The disk drive unit 515 may include a computer-readable medium 540 in which one or more sets of instructions 545, e.g. software, can be embedded. Further, the instructions 545 may perform one or more of the operations as described herein. The instructions 545 may reside completely, or at least partially, within the memory 510 and/or within the processor 505 during execution by the computer system 500. The memory 510 and the processor 505 also may include computer-readable media as discussed above.

The computer system 500 may include a communication interface 535 that enables communications via a network 550. The network 550 may include wired networks, wireless networks, or combinations thereof. The communication interface 535 network may enable communications via any number of communication standards, such as 802.11, 802.12, 802.20, WiMax, cellular telephone standards, or other communication standards.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The method and system may also be embedded in a computer program product, which includes all the features enabling the implementation of the operations described herein and which, when loaded in a computer system, is able to carry out these operations. Computer program in the present context means any expression, in any language, code or notation, of a set of instructions intended to cause a system having an information processing capability to perform a particular function, either directly or after either or both of the following: a) conversion to another language, code or notation; b) reproduction in a different material form.

As shown above, the system for serving advertisements overcomes the problems described above by enabling an advertiser to enter into a contract with a publisher for a) the delivery of a number of impressions to opportunities that match targeting information in the contract, and b) delivering clicks and/or conversions for a money amount specified in the contract. The system includes an optimizer configured to receive a forecast of a supply of opportunities, a forecast of a supply of guaranteed contracts, and a forecast of a supply of non-guaranteed contracts, wherein each opportunity represents a user visiting a webpage, each guaranteed contract guarantees the matching of an advertisement to a number of opportunities, and wherein each non-guaranteed contract guarantees a user event associated with an advertisement. The optimizer then generates a plan for matching contracts to opportunities based on the forecasted supply of opportunities, the forecasted supply of guaranteed contracts, the forecasted supply of non-guaranteed contracts, and an objective function that balances a group of parameters that define the representativeness of contracts, a cost associated with not serving non-guaranteed contracts, and performance objectives associated with contracts

While the method and system has been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present method and system not be limited to the particular embodiment disclosed, but that the method and system include all embodiments falling within the scope of the appended claims.

We claim:

1. A network based advertisement method, the method comprising:
receiving, via an advertisement booking system, information that defines a number of advertisement impressions to be communicated to users that match targeting parameters and information that defines performance objectives associated with a user event associated with the advertisement impressions;
selecting, via an advertisement server, users that match the targeting parameters, wherein users are selected at least in part so as to achieve the performance objectives; and
communicating the number of advertisement impressions to users that match the targeting parameters.

2. The method according to claim 1, wherein the performance objectives specify an amount charged when the user event occurs.

3. The method according to claim 1, wherein the user event corresponds to a click on an advertisement or a conversion.

4. A network based advertisement method, the method comprising:
communicating, to an optimizer, data that defines a supply of opportunities, a supply of guaranteed contracts, and a supply of non-guaranteed contracts, wherein each opportunity represents a user visiting a webpage, each guaranteed contract guarantees the matching of an advertisement to a number of opportunities, and each non-guaranteed contract guarantees a user event associated with an advertisement;
generating, by the optimizer, a plan for matching contracts to opportunities based on the supply of opportunities, the supply of guaranteed contracts, the supply of non-guaranteed contracts, and an objective function that balances a group of parameters that define the representativeness of contracts, a cost associated with not serving non-guaranteed contracts, and performance objectives associated with contracts.

5. The method according to claim 4, further comprising communicating the plan to an advertisement server configured to match opportunities to contracts according to the plan.

6. The method according to claim 4, wherein the group of parameters includes a parameter that defines user-similarity objectives associated with contracts.

7. The method according to claim 4, further comprising adjusting a weight associated with each parameter to enable generation of a plan that increases the probability of matching contracts to opportunities according to parameters with a higher weight.

8. The method according to claim 4, wherein the guaranteed contracts define user target information and performance information that defines an amount charged when a user event occurs.

9. The method according to claim 8, wherein the target information includes a list of user with characteristics similar to a target audience.

10. The method according to claim 4, wherein the user event corresponds to a click on an advertisement or a conversion.

11. A network based advertisement system comprising:
an optimizer configured to:
receive data that defines a supply of opportunities, a supply of guaranteed contracts, and a supply of non-guaranteed contracts, wherein each opportunity represents a user visiting a webpage, each guaranteed contract guarantees the matching of an advertisement to a number of opportunities, and wherein each non-guaranteed contract guarantees a user event associated with an advertisement; and
generate a plan for matching contracts to opportunities based on the supply of opportunities, the supply of guaranteed contracts, the supply of non-guaranteed contracts, and an objective function that balances a group of parameters that define the representativeness of contracts, a cost associated with not serving non-guaranteed contracts, and performance objectives associated with contracts.

12. The system according to claim 11, wherein the optimizer is further configured to communicate the plan to an advertisement server configured to match opportunities to contracts according to the plan.

13. The system according to claim 11, wherein the group of parameters includes a parameter that defines user-similarity objectives associated with contracts.

14. The system according to claim 11, wherein the objective function includes weight parameters that enable adjustment of a weight associated with each parameter to enable generation of a plan that increases the probability of matching contracts to opportunities according to parameters with a higher weight.

15. The system according to claim 11, wherein the guaranteed contracts define user target information and performance information that defines an amount charged when a user event occurs.

16. The system according to claim 15, wherein the target information includes a list of users with characteristics similar to a target audience.

17. The system according to claim 11, wherein the user event corresponds to a click on an advertisement or a conversion.

18. A machine-readable storage medium having stored thereon a computer program comprising at least one code section for operating a networked based advertisement system, the at least one code section being executable by a machine for causing the machine to perform acts of:
communicating data that defines a supply of opportunities, a supply of guaranteed contracts, and a supply of non-guaranteed contracts, wherein each opportunity represents a user visiting a webpage, each guaranteed contract guarantees the matching of an advertisement to a number of opportunities, and wherein each non-guaranteed contract guarantees a user event associated with an advertisement; and
generating a plan for matching contracts to opportunities based on the supply of opportunities, the supply of guaranteed contracts, the supply of non-guaranteed contracts, and an objective function that balances a group of parameters that define the representativeness of contracts, a cost associated with not serving non-guaranteed contracts, and performance objectives associated with contracts.

19. The machine-readable storage medium according to claim 18, wherein the at least one code section is operable to cause the machine to communicate the plan to an advertisement server configured to match opportunities to contracts according to the plan.

20. The machine-readable storage medium according to claim 18, wherein the group of parameters includes a parameter that defines user-similarity objectives associated with contracts.

21. The machine-readable storage medium according to claim 18, wherein the at least one code section is operable to cause the machine to adjust a weight associated with each parameter to enable generation of a plan that increases the probability of matching contracts to opportunities according to parameters with a higher weight.

22. The machine-readable storage medium according to claim 18, wherein the guaranteed contracts define user target information and performance information that defines an amount charged when a user event occurs.

23. The machine-readable storage medium according to claim 22, wherein the target information includes a list of users with characteristics similar to a target audience.

24. The machine-readable storage medium according to claim 18, wherein the user event corresponds to a click on an advertisement or a conversion.
